(19) United States
(12) Patent Application Publication
(10) Pub. No.: US 2022/0019616 A1
(43) Pub. Date: Jan. 20, 2022

(54) CONTENT DISPLAY DEVICE AND CONTENT DISPLAY METHOD

(71) Applicant: Faurecia Clarion Electronics (Xiamen) Co., Ltd., Xiamen (CN)

(72) Inventors: Yonglin FU, Xiamen, Fujian (CN); Yong HUANG, Xiamen (CN)

(73) Assignee: Faurecia Clarion Electronics (Xiamen) Co., Ltd., Xiamen (CN)

(21) Appl. No.: 17/371,777

(22) Filed: Jul. 9, 2021

(30) Foreign Application Priority Data
Jul. 14, 2020 (CN) 202010675953.3

(51) Int. Cl. G06F 16/54; G06F 16/58; G06F 16/51; G06F 16/538

(52) U.S. Cl. CPC G06F 16/54; G06F 16/5866; G06K 9/00845; G06F 16/538; G06F 16/51

(57) ABSTRACT

A content display method includes: obtaining target information; determining a target tag according to a first database at a current moment and the target information; obtaining top M pieces of content in the target tag; and displaying the content. The target information includes vehicle state information at the current moment and first information used to characterize a facial expression of a driver in a vehicle at the current moment; and the first database includes a plurality of pieces of historical information corresponding to the driver in a historical period.

### CROSS-REFERENCE TO RELATED APPLICATION

This application claims priority to Chinese Patent Application No. 202010675953.3, filed on Jul. 14, 2020, which is incorporated herein by reference in its entirety.

### TECHNICAL FIELD

The present disclosure relates to the field of information processing technology, and in particular, to a content display device and a content display method.

### BACKGROUND

As the automobile industry develops toward smart vehicles, in-vehicle infotainment (IVI) has become a particularly critical part of the smart vehicle trend. Adopting a dedicated vehicle-mounted central processing unit (CPU), IVI is a vehicle-mounted integrated information processing system based on the vehicle body bus system and Internet services. IVI provides users with three-dimensional navigation, real-time road conditions, wireless communication, on-line entertainment, and other services.

### SUMMARY

In a first aspect, a content display device is provided. The content display device includes a processor configured to: obtain target information, the target information including vehicle state information at a current moment and first information, the first information being used to characterize a facial expression of a driver in a vehicle at the current moment, and the vehicle state information including vehicle speed, vehicle position, and driving time; determine a target tag according to a first database at the current moment and the target information, first database including a plurality of pieces of historical information corresponding to the driver in a historical period, each piece of historical information including the vehicle state information, the facial expression of the driver, and a first tag, the vehicle state information, the facial expression of the driver, and the first tag all corresponding to a same moment in the historical period (a first moment), and the first tag being a tag determined according to vehicle state information at the first moment and the facial expression of the driver at the first moment; and obtain top M pieces of content in the target tag and display the top M pieces of content on a display screen, M being a positive integer.

In a second aspect, a content display method is provided. The content display method includes: obtaining target information; determining a target tag according to the target information and a first database at the current moment; obtaining top M (M is a positive integer) pieces of content in the target tag, and display the top M pieces of content. The target information includes vehicle state information at a current moment and first information. The first information is used to characterize a facial expression of a driver in a vehicle at the current moment. The vehicle state information includes vehicle speed, vehicle position, and driving time. The first database includes a plurality of pieces of historical information corresponding to the driver in a historical period. Each piece of historical information includes vehicle state information at a first moment, a facial expression of the driver at the first moment, and a first tag. The first moment falls within the historical period; and the first tag is a tag determined according to the vehicle state information at the first moment and the facial expression of the driver at the first moment.

In a third aspect, a content display device is provided. The content display device includes a processor. The processor is used to be coupled to a memory and read and execute instructions in the memory, so as to implement the content display method as provided in the second aspect.

In some embodiments, the content display device further includes a memory. The memory is used to store program instructions and data of the content display device. Optionally, the content display device further includes a transceiver, and the transceiver is used to perform steps of sending and receiving data, signaling, or information under control of the processor of the content display device. For example, the transceiver is used to obtain target information.

In some embodiments, the content display device is a server, is a part of devices in the server. For example, the content display device is a chip system in the server. The chip system is used to support the content display device to implement functions involved in the second aspect. For example, the chip system is used to receive, send or process data and/or information involved in the above content display method. The chip system includes a chip, and may also include other discrete devices or circuit structures.

In a fourth aspect, a non-transitory computer-readable storage medium is provided. The non-transitory computer-readable storage medium has stored thereon instructions. When the instructions are executed by a computer, the content display method as provided in the second aspect is implemented.

In a fifth aspect, a computer program product is provided. The computer program product includes computer instructions carried on a non-transitory computer-readable storage medium. When executed on a computer, the computer instructions cause the computer to perform the content display method as described in the second aspect.

### BRIEF DESCRIPTION OF THE DRAWINGS

FIG. 1 is a schematic diagram showing a structure of a content display system, in accordance with some embodiments;

FIG. 2 is a first schematic flow diagram of a content display method, in accordance with some embodiments;

FIG. 3 is a schematic diagram of a four-dimensional space model, in accordance with some embodiments;

FIG. 4 is a schematic diagram of a five-dimensional space model, in accordance with some embodiments;

FIG. 5 is a second schematic flow diagram of a content display method, in accordance with some embodiments;

FIG. 6 is a third schematic flow diagram of a content display method, in accordance with some embodiments;

FIG. 7 is a fourth schematic flow diagram of a content display method, in accordance with some embodiments;

FIG. 8 is a fifth schematic flow diagram of a content display method, in accordance with some embodiments;

FIG. 9 is a schematic diagram showing a system architecture of a content display device, in accordance with some embodiments; and

FIG. 10 is a schematic diagram showing a system architecture of another content display device, in accordance with some embodiments.

### DETAILED DESCRIPTION

Content display devices and a content display method provided by embodiments of the present disclosure will be described in detail below with reference to the accompanying drawings.

The term “and/or” herein is merely used to describe an association relationship of associated objects, which includes three kinds of relationships. For example, the phrase “A and/or B” may include three situations: A alone, A and B, and B alone.

Terms such as “first” and “second” in the description of the present disclosure and the accompanying drawings are used to distinguish different objects, or to distinguish different treatments of a same object, rather than to describe specific orders of objects.

In addition, the terms “including” and “having” and any variations thereof in the description are intended to cover non-exclusive inclusion. For example, a process, method, system, product, or device that includes a series of steps or units is not limited to the listed steps or units, but optionally further includes other steps or units that are not listed, or optionally further includes other steps or units inherent to the process, method, system, product, or device.

It will be noted that in the embodiments of the present disclosure, the words such as “for example” or “such as” are used to indicate examples, illustrations or explanations. Any embodiment or design solution described as “for example” or “such as” in the embodiments of the present disclosure should not be construed as being more preferable or more advantageous than other embodiments or design solutions. To be precise, the use of the words such as “for example” or “such as” is intended to present related concepts in a specific manner.

In the description, “a plurality of”, “the plurality of” and “multiple” mean two or more unless otherwise specified.

As the automobile industry develops toward smart vehicles, in-vehicle infotainment (IVI) has become a particularly critical part of the smart vehicle trend. Adopting a dedicated vehicle-mounted central processing unit (CPU), IVI is a vehicle-mounted integrated information processing system based on the vehicle body bus system and Internet services. IVI provides users with three-dimensional navigation, real-time road conditions, wireless communication, on-line entertainment, and other services.

However, since the IVI offers a variety of entertainment items, it may not be able to provide an entertainment item that is needed by the driver, resulting in a low information processing efficiency.

In view of the above problem in the prior art, some embodiments of the present disclosure provide a content display method. By analyzing target information and a plurality of pieces of historical information in a first database, and by displaying top M pieces of content in a target tag, the content display method may be able to determine a tag that is in line with the driver's preference at a current moment, and recommend content needed by the driver to the driver. In this way, the driver does not need to spend a lot of time to select content that matches with his own preference. That is, content in line with a user's preference may be directly recommended to the user, thereby improving the information processing efficiency.

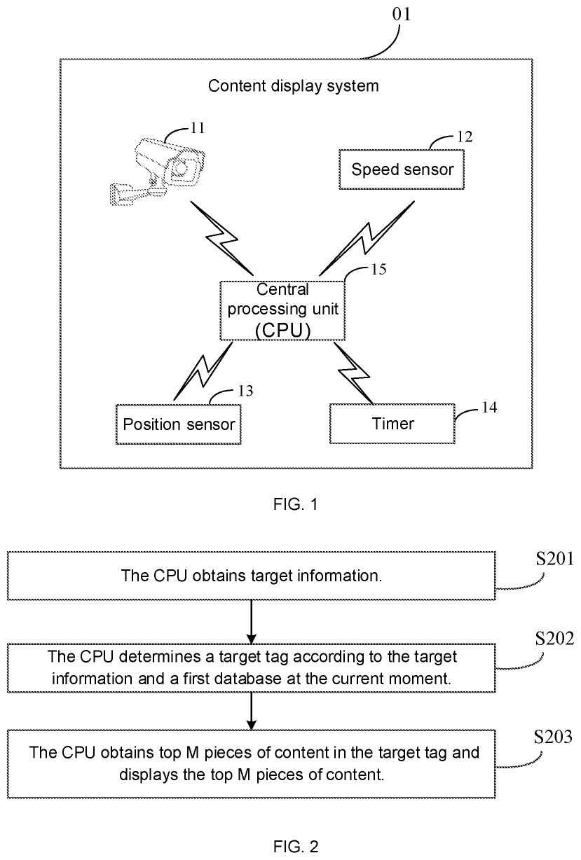

The content display method provided in some embodiments of the present disclosure may be applicable to a content display system. FIG. 1 shows a possible structure of a content display system 01. As shown in FIG. 1, the content display system 01 includes an image capture device 11, a speed sensor 12, a position sensor 13, a timer 14, and a CPU 15.

The image capture device 11 may be a device used to capture a face image, such as a face capture camera. The speed sensor 12 may be able to detect a real-time driving speed of the vehicle. The position sensor 13 may be able to determine a real-time position of the vehicle. The timer 14 may be able to record a driving time of the vehicle. The image capture device 11, the speed sensor 12, the position sensor 13, and the timer 14 may all be disposed on the vehicle. The image capture device 11, the speed sensor 12, the position sensor 13, and the timer 14 will send information obtained in real time to the CPU 15.

The CPU 15 is used to analyze and process the information sent by the image capture device 11, the speed sensor 12, the position sensor 13, and the timer 14, so as to determine a target tag, obtain the top M pieces of content in the target tag, and display the top M pieces of content on a display screen. In practical applications, the CPU 15 may be a CPU of a vehicle-mounted navigator, or may be a CPU of a remotely deployed server. Hereinafter, the embodiments of the present disclosure will be described by taking an example in which the CPU 15 is a CPU of a vehicle-mounted navigator.

The content display method provided in the embodiments of the present disclosure will be described below with reference to the content display system shown in FIG. 1.

Referring to FIG. 2, the content display method includes steps 201-205 (S201-S205).

In S201, the CPU obtains target information.

The target information includes vehicle state information at a current moment and first information, and the first information is used to characterize a facial expression of the driver in the vehicle at the current moment. The CPU may receive the vehicle state information at the current moment and obtain the first information, so as to obtain the target information; then, the CPU may analyze the obtained target information to determine content that are in line with the preference of the driver in the vehicle at the current moment.

The facial expression of the driver at the current moment may effectively reflect a mood of the driver at the current moment, and the driver may prefer different content in different moods. For example, when the driver is angry, he may like to listen to some light music to soothe his mood. The vehicle state information at the current moment may characterize the driving state of the driver at the current moment, and the same driver may have different preferences in different driving states. The vehicle state information includes vehicle speed, vehicle position, and driving time. The driver may have different preferences when driving fast or driving slow, and may have different preferences after driving for a long time or after driving for a short time. In addition, the driver may have different preferences when driving the vehicle in different geographic positions. For example, the driver may have different preferences when driving on a winding mountain road or driving on a straight road. Therefore, the CPU may be able to analyze the driver's preferences by analyzing the vehicle state information and the driver's facial expression.

It will be noted that, in some embodiments of the present disclosure, the driving time in the vehicle state information refers to a total driving duration of the vehicle as of the current moment during this trip.

Of course, in practical applications, the current vehicle state information may also include other information, which is not limited in the embodiments of the present disclosure. For example, the driver's preferences may be different when the weather is sunny or cloudy. Therefore, the current vehicle state information may also include the current weather of the geographic position of the vehicle.

In some embodiments, the CPU may obtain a face image of the driver at the current moment, and then use a preset image processing algorithm to process the face image to determine the first information.

The face image of the driver at the current moment may be captured by an image capture device used to capture a face image. After capturing the face image of the driver at the current moment, the image capture device may send the face image to the CPU. After obtaining the face image, the CPU may use the preset image processing algorithm to process the face image, so as to determine a facial expression of the driver at the current moment. For example, the facial expressions determined by the CPU using the preset image processing algorithm may include expressions of joy, anger, sadness, panic, and disgust.

In a possible implementation, the CPU may build “face models” of different facial expressions based on characteristic values of the human face. For example, a happy facial expression corresponds to a first “face model”, and a sad facial expression corresponds to a second “face model”. After obtaining the face image of the driver at the current moment, the CPU may use the preset image processing algorithm to process the face image, and extract a characteristic value of the face image, and compare the characteristic value of the face image with the characteristic values of the pre-established “face models” one by one. For example, when the characteristic value of the face image most similar to a characteristic value of the first “face model”, it may be determined that the facial expression in the face image is joy.

It will be understood that the embodiments of the present disclosure only described a possible implementation of the CPU using the preset image processing algorithm to process the face image at the current moment so as to determine the facial expression of the driver at the current moment. In practical applications, the facial expression in the face image may be determined in other ways, which is not limited in the present disclosure. As for specific implementations, reference may be made to related descriptions in the field of face image processing in the prior art, which will not be elaborated here.

In S202, the CPU determines a target tag according to the target information and a first database at the current moment.

The first database includes a plurality of pieces of historical information corresponding to the driver in the vehicle in a historical period. Each piece of historical information includes vehicle state information at a first moment, a facial expression of the driver at the first moment, and a first tag. The first moment falls within the historical period, and the first tag is a tag determined according to the vehicle state information at the first moment and the facial expression of the driver at the first moment.

In some embodiments, the target tag may be a program tag of a certain type of entertainment program. For example, the target tag may be folk music, rock music, light music, etc. in a music program, or may be a music broadcast, a traffic broadcast, etc. in a radio program.

It will be noted that the number of attributes of the vehicle state information contained in the historical information should be the same as the number of attributes of the vehicle state information contained in the target information. For example, in a case where the target information includes vehicle speed at the current moment, vehicle position, driving time, and the weather in the geographic position of the vehicle at the current moment, the vehicle state information contained in the historical information includes: the vehicle speed at the first moment, the vehicle position at the first moment, the driving time at the first moment, and the weather in the geographic position of the vehicle at the first moment.

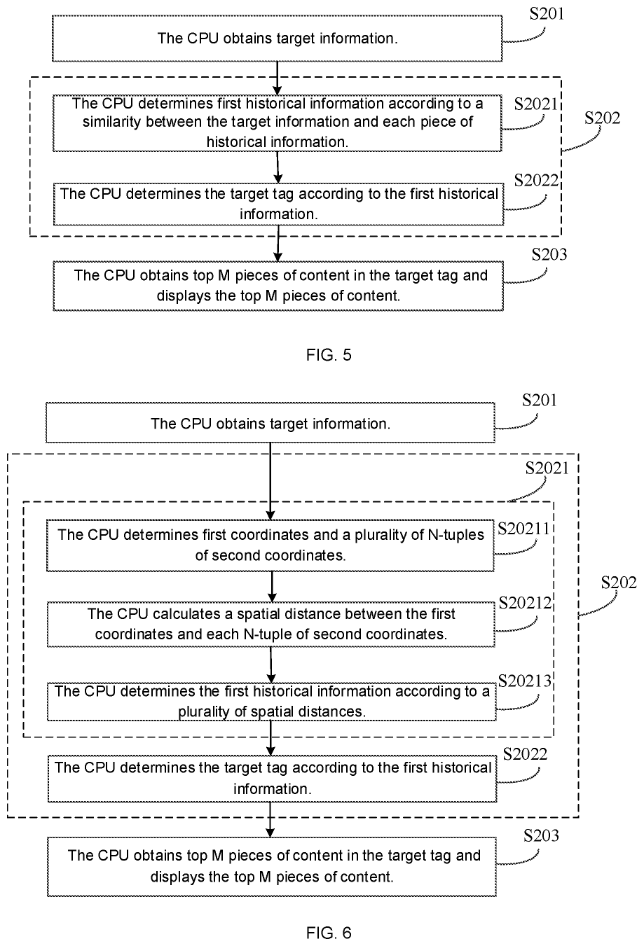

In some embodiments, as shown in FIG. 5, S202 in FIG. 2 includes the steps 2021 and 2022 (S2021 and S2022).

In S2021, the CPU determines first historical information according to a similarity between the target information and each piece of historical information.

In S2022, the CPU determines the target tag according to the first historical information.

According to the similarity between the target information and each piece of historical information in the first database, the CPU may determine, among the plurality of pieces of historical information, the historical information (corresponding to the first historical information in the embodiments of the present disclosure) a similarity between which and the target information satisfies a preset condition, and then determine the target tag according to the first historical information.

In a possible implementation, the preset condition may be that a value of the similarity between the historical information and the target information reaches a preset threshold. For example, the first database includes historical information A, historical information B, and historical information C. The CPU may analyze the similarity between the facial expression, vehicle speed, vehicle position, and driving time in the target information and corresponding information in each piece of historical information. If the similarity between the target information and the historical information A reaches 93%, and the preset threshold is set to 90%, the CPU may determine that the historical information A is the first historical information.

In another possible implementation, top K pieces of historical information most similar to the target information may be the historical information that meets the preset condition. For example, the first database includes historical information A, historical information B, historical information C, historical information D, and historical information E. The CPU may analyze the similarity between the facial expression, vehicle speed, vehicle position, and driving time in the target information and corresponding information in each piece of historical information. If the similarity between the target information and the historical information A reaches 15%, the similarity between the target information and the historical information B reaches 55%, the similarity between the target information and the historical information C reaches 75%, the similarity between the target information and the historical information D reaches 83%, the similarity between the target information and the historical information E reaches 92%, and a value of K is set to 3, the CPU may determine that the historical information C, the historical information D, and the historical information E are the first historical information.

In some embodiments, as shown in FIG. 6, S2021 in FIG. 5 includes steps 20211 to 20213 (S20211 and S20213).

In S20211, the CPU determines first coordinates and a plurality of N-tuples of second coordinates.

In S20212, the CPU calculates a spatial distance between the first coordinates and each N-tuple of second coordinates.

In S20213, the CPU determines the first historical information according to a plurality of spatial distances.

In a possible implementation, the facial expression, vehicle speed, vehicle position, driving time, etc. may be quantified and represented by numerical values in a coordinate system. For example, an N-dimensional space model may be used to represent the plurality of pieces of historical information. Each dimension represents an attribute. The attributes may include facial expression of the driver, vehicle speed, vehicle position, and driving time. Of course, in practical applications, the attributes may also include other information. For example, the attributes may also include the weather in the geographic position of the vehicle at the first moment.

For example, the CPU may determine the coordinates of the target information (i.e., the first coordinates) in the N-dimensional space model, and the coordinates of each piece of historical information (i.e., the N-tuples of second coordinates) in the N-dimensional space model, and then calculate a spatial distance between the first coordinate and each N-tuple of second coordinates. The spatial distance is used to characterize the similarity between the target information and the historical information. After that, the CPU may determine the first historical information according to the plurality of spatial distances that are obtained through calculation. For example, the CPU may determine historical information corresponding to K N-tuples of second coordinates, among the plurality of second coordinates, that have smallest distances with the first coordinates as the first historic information. That is, the CPU may determine K pieces of first historical information.

It will be noted that, in order to make the program tag determined by the CPU more in line with the driver's preference, a value of N cannot be too small. In some embodiments, N is a positive integer greater than 3. That is, the space model is at least a four-dimensional space model.

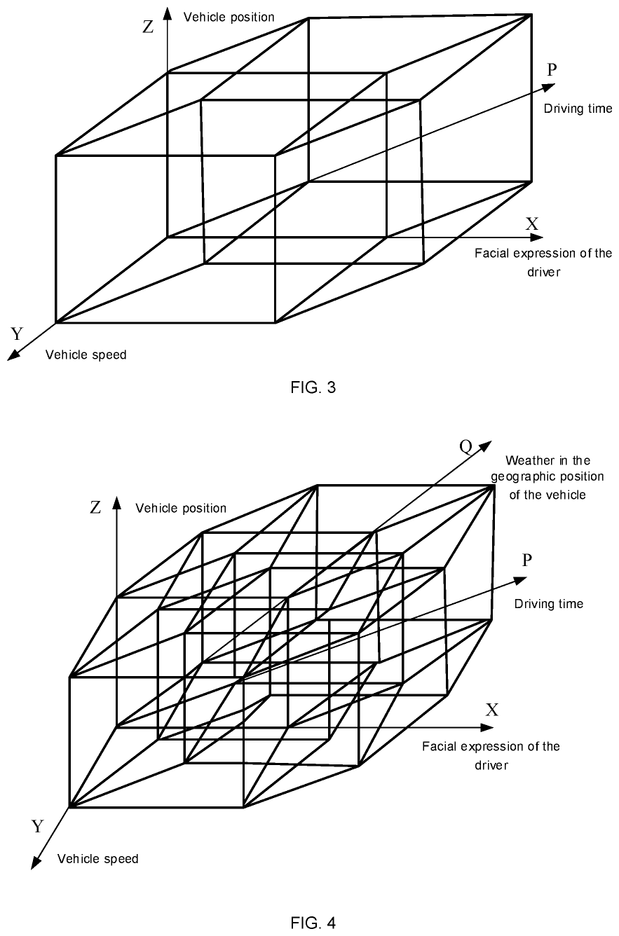

FIG. 3 shows a four-dimensional space model provided by some embodiments of the present disclosure. As shown in FIG. 3, an X-axis is used to represent the facial expression of the driver, a Y-axis is used to represent the vehicle speed, a Z-axis is used to represent the vehicle position, and a P-axis is used to represent the driving time.

FIG. 4 shows a five-dimensional space model provided by some embodiments of the present disclosure. As shown in FIG. 4, the X-axis is used to represent the facial expression of the driver, the Y-axis is used to represent the vehicle speed, the Z-axis is used to represent the vehicle position, the P-axis is used to represent the driving time, and a Q-axis is used to represent the weather in the geographic position of the vehicle.

In addition, in the N-dimensional space model, if the first coordinates are (x₁₁, x₁₂, . . . , x₁ₙ), and the second coordinates are (x₂₁, x₂₂, . . . , x₂ₙ), then the spatial distance between the first coordinates and the second coordinates may be represented as d:

d=\sqrt{Σₛ₌₁ⁿ(x₁ₛ−x₂ₛ)²}.

Taking the five-dimensional space model provided in FIG. 4 as an example, if the first coordinates are (x₁₁, x₁₂, x₁₃, x₁₄, x₁₅), and the second coordinates are (x₂₁, x₂₂, x₂₃, x₂₄, x₂₅), then the spatial distance between the first coordinates and the second coordinates may be represented as d₁₂:

$${d}_{12} = \sqrt{{( {x}_{11} - {x}_{21} )}^{2} + {( {x}_{12} - {x}_{22} )}^{2} + {( {x}_{13} - {x}_{23} )}^{2} + {( {x}_{14} - {x}_{24} )}^{2} + {( {x}_{15} - {x}_{25} )}^{2}} .$$

After determining the first historical information, the CPU may determine the target tag according to the first historical information. In a possible implementation, after determining the K pieces of first historical information, the CPU may analyze first tags in the K pieces of first historical information to determine the numbers of different tags, and then the CPU may determine a tag in the largest number as the target tag. For example, after determining the K pieces of first historical information, the CPU determines that the number of tags of traffic broadcasts in the broadcast program in the K pieces of first historical information is the largest; then, the CPU may determine traffic broadcast in the broadcast program as the target tag.

Of course, in practical applications, there may be a situation in which two tags are in the largest number in the K pieces of first historical information. For example, after determining the K pieces of first historical information, the CPU determines that the number of music broadcasts and the number of traffic broadcasts in the broadcast program are the same in the K pieces of first historical information, and they are both more than the numbers of other tags. In this case, the CPU may determine that historical information corresponding to (K+1) N-tuples of second coordinates having the smallest spatial distance with the first coordinates as the first historical information, and then re-determine the target tag.

K is a pre-set value. Generally, the value of K is set between 3 and 30. For example, K is set to 8.

Since different drivers have different preferences, the first database is different for different drivers. In some embodiments, before determining the target tag according to the target information and the first database at the current moment, the CPU may also determine the first database corresponding to the driver in the current vehicle according to the obtained face image.

In S203, the CPU obtains top M pieces of content in the target tag and displays the top M pieces of content.

After obtaining the target tag, the CPU may recommend the top M pieces of content in the target tag to the driver by displaying the top M pieces of content on a display screen. M is a positive integer. The top M pieces of content in the target tag may be the top M pieces of content determined by the CPU through big data analysis.

In a possible implementation, after the vehicle is started, a virtual button of “Smart Recommendation” is displayed on the display screen of the vehicle. When the driver presses “Smart Recommendation” button, the display screen will display the top M pieces of content in the target tag determined by the CPU in real time. It will be noted that in this embodiment, the driver pressing “Smart Recommendation” button is only an operation to trigger the display screen to display the content determined by the CPU, and the process of the CPU from acquiring information to processing information (i.e., from obtaining the target information to obtaining the top M pieces of content in the target tag) is always running in the background of the CPU.

For example, when the driver presses “Smart Recommendation” virtual button for once, the content display device provided by some embodiments of the present disclosure will always be in the “Smart Recommendation” mode. That is, the top M pieces of content in the target tag determined by the CPU in real time will be displayed on the display screen, and the content displayed on the display screen will be updated as the content determined by the CPU changes. In a possible implementation, a virtual button of “Exit Smart Recommendation” will be displayed on the display screen of the vehicle. After the driver presses the “Exit Smart Recommendation” button, the display screen will not display the top M pieces of content in the target tag determined by the CPU in real time, but the process of acquiring information and processing information of the CPU is still running in the background.

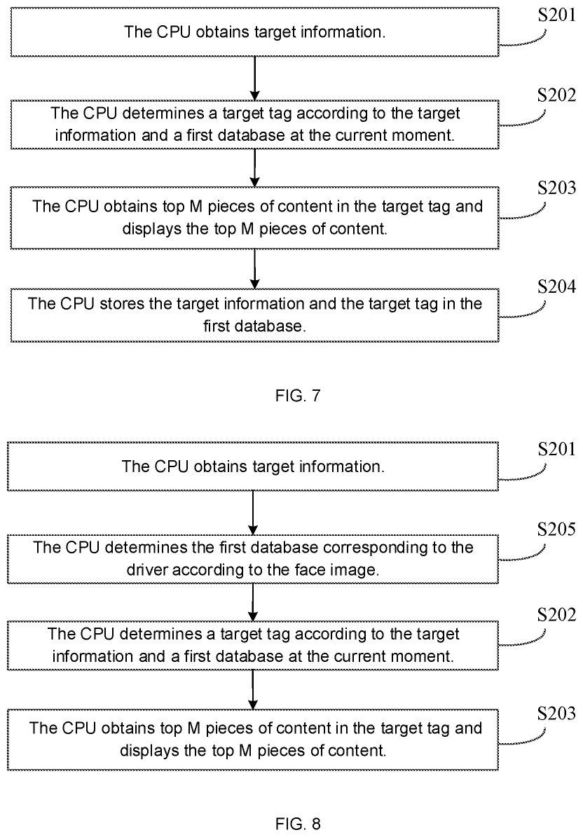

In some embodiments, as shown in FIG. 7, the content display method further includes step 204 (S204).

In S204, the CPU stores the target information and the target tag in the first database.

The first database in some embodiments of the present disclosure is not fixed. After determining the target tag, the CPU will store the determined target tag and target information corresponding to the target tag, as a new piece of historical information, in the first database, so as to enrich data in the first database. As the historical information in the first database increases, the determined target tag is closer to the preference of the driver in the current vehicle.

In some embodiments, as shown in FIG. 8, before S202, the content display method further includes step 205 (S205).

In S205, the CPU determines the first database corresponding to the driver according to the face image.

It will be noted that, after the CPU obtains the face image of the driver in the current vehicle, if it fails to find a first database corresponding to the driver, it will need to create a first database corresponding to the driver. In this case, since there is no historical information of the driver, the CPU may obtain the top N pieces of content that match all drivers from the Internet, and output the top N pieces of content. If the driver does not perform any operation within a preset time period, it indicates that the recommended content at this moment are in line with the driver's preferences, and the CPU will store the target information at this moment and the tag of the recommended content in the first database corresponding to the driver. If the driver triggers an operation to change the recommended content within the preset time period (e.g., by clicking on a “Switch” button), the CPU will store the target information at this moment and the tag corresponding to the content after the switching in the first database corresponding to the driver.

Different drivers have different preferences, and the same driver has different preferences in different moods or different driving conditions. The facial expression of the driver at the current moment may effectively reflect the mood of the driver at the current moment, and the current vehicle state information may characterize the driving state of the driver at the current moment. Therefore, the driver's preferences can be obtained by analyzing the vehicle state information and the driver's facial expression. In some embodiments of the present disclosure, the target tag is determined with reference to the plurality of pieces of historical information corresponding to the current driver in the historical period, and each piece of historical information includes the vehicle state information and the driver's facial expression corresponding to a same moment (i.e., corresponding to the first moment in the embodiments of the present disclosure), and the corresponding tag. Therefore, the top M pieces of content in the target tag are the content that matches the current driver's preferences. It can be seen that, by analyzing the target information and the plurality of pieces of historical information in the first database, the content display method provided by the embodiments of the present disclosure may be able to determine the target tag that is in line with the driver's preference at the current moment, and display the top M pieces of content in the target tag, so as to recommend the top M pieces of content to the driver. In this way, it may be possible to directly recommend content that are in line with the user's preferences to the user, and thus improve the information processing efficiency.

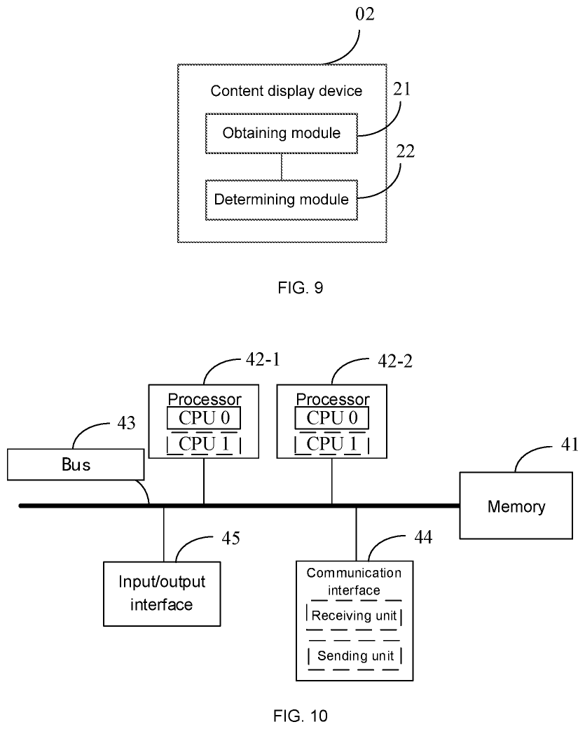

As shown in FIG. 9, some embodiments of the present disclosure further provide a content display device 02. The content display device 02 may be the CPU 15 in the content display system shown in FIG. 1, and the content display device 02 includes an obtaining module 21 and a determining module 22.

The obtaining module 21 performs S201 and S203 in the foregoing method embodiment, and the determining module 22 performs S202 in the foregoing method embodiment.

The obtaining module 21 is used to obtain target information. The target information includes vehicle state information at a current moment and first information. The first information is used to characterize a facial expression of a driver in a vehicle at the current moment, and the vehicle state information includes vehicle speed, vehicle position, and driving time.

The determining module 22 is used to determine a target tag according to a first database at the current moment and the target information obtained by the obtaining module 21. The first database includes a plurality of pieces of historical information corresponding to the driver in a historical period. Each piece of historical information includes vehicle state information at a first moment, a facial expression of the driver at the first moment, and a first tag. The first moment falls within the historical period; and the first tag is a tag determined according to the vehicle state information at the first moment and the facial expression of the driver at the first moment.

The obtaining module 21 is also used to obtain top M pieces of content in the target tag determined by the determining module 22, so as to display the top M pieces of content through a display module. M is a positive integer.

In some embodiments, the obtaining module 21 is specifically used to obtain a face image of the driver at the current moment, and determine the first information by using a preset image processing algorithm to process the face image.

In some embodiments, the determining module 22 includes: a first determining sub-module and a second determining sub-module. The first determining sub-module is used to determine first historical information according to a similarity between the target information obtained by the obtaining module 21 and each piece of historical information. The first historical information is historical information, among the plurality of pieces of historical information, a similarity between which and the target information satisfies a preset condition. The second determining sub-module is used to determine the target tag according to the first historical information determined by the first determining sub-module.

In some embodiments, the plurality of pieces of historical information are represented by an N-dimensional space model. Each dimension represents an attribute. The attributes include facial expression of the driver, vehicle speed, vehicle position, and driving time. N is a positive integer greater than 3. The first determining sub-module is specifically used to: determine first coordinates and a plurality of N-tuples of second coordinates; calculate a spatial distance between the first coordinates and each N-tuple of second coordinates; and determine the first historical information according to a plurality of spatial distances. The first coordinates are coordinates of the target information in the N-dimensional space model; the second coordinates are coordinates of the historical information in the N-dimensional space model; and the spatial distance is used to characterize the similarity between the target information and the historical information.

In some embodiments, the content display device 02 provided by some embodiments of the present disclosure further includes: a processing module used to store the target information and the target tag in the first database.

In some embodiments, the determining module 22 is further used to determine a first database corresponding to the driver according to the face image obtained by the obtaining module 21.

In some embodiments, the content display device 02 further includes a storage module. The storage module 34 is used to store a program code of the content display device 02, etc.

As shown in FIG. 10, some embodiments of the present disclosure further provide a content display device, which includes a memory 41, a processor 42, a bus 43, a communication interface 44, and an input/output interface 45. The memory 41 is used to store computer executable instructions. The processor 42, the memory 41, the communication interface 44, and the input/output interface 45 communicate with each other within the device via the bus 43. When the content display device is running, the processor 42 executes the computer executable instructions stored in the memory 41, so that the content display device performs the content display method as provided in the above embodiments.

In a specific implementation, as an embodiment, the processor 42 (42-1 and 42-2) may include one or more CPUs, for example, CPU 0 and CPU 1, as shown in FIG. 10. As an embodiment, the content display device may include a plurality of processors 42, for example, a processor 42-1 and a processor 42-2, as shown in FIG. 10. Each CPU of the processors 42 may be a single-core CPU (single-CPU) or a multi-core CPU (multi-CPU). The processor 42 here may refer to one or more devices, circuits, and/or processing cores for processing data (e.g., computer program instructions).

For example, the memory 41 may be a read-only memory (ROM) or other types of static storage devices that may store static information and instructions, a random access memory (RAM) or other types of dynamic storage device that may store information and instructions, an electrically erasable programmable read-only memory (EEPROM), a compact disc read-only memory (CD-ROM) or other types of compact disc storage, optical disc storage (including compressed discs, laser discs, optical discs, digital versatile discs, and Blu-ray discs), magnetic disc storage medium or other magnetic storage devices, or any other medium that can be used to carry or store a desired program code in the form of instructions or data structures and can be accessed by a computer, which is not limited thereto. The memory 41 may exist independently, and may be coupled to the processor 42 via the bus 43. The memory 41 may also be integrated with the processor 42.

In a specific implementation, the memory 41 is used to store data in the present disclosure and execute computer executable instructions corresponding to a software program of the present disclosure. The processor 42 may implement, by running or executing the software program stored in the memory 41 and calling data stored in the memory 41, various functions of the content display device.

The communication interface 44, using any device such as a transceiver, is used to communicate with other devices or communication networks, such as a control system, a radio access network (RAN), and a wireless local area network (WLAN). The communication interface 44 may include a receiving unit to implement a receiving function, and a sending unit to implement a sending function.

The bus 43 may be an industry standard architecture (ISA) bus, a peripheral component interconnect (PCI) bus, or an extended industry standard architecture (EISA) bus. The bus 43 may be divided into an address bus, a data bus, a control bus, etc. For convenience of demonstration, the bus 43 is indicated by only one thick line in FIG. 10, but it does not mean that there is only one bus or one type of bus.

The input/output interface 45 is used to connect an input/output device, so as to realize input and output of information. The input/output device may be configured in the device as a component (not shown in the figure), or may be external devices to provide corresponding functions. The input device may include a keyboard, a mouse, a touch screen, a microphone, and various kinds of sensors, and the output device may include a display screen, a speaker, a vibrator, and an indicator light.

As an example, in combination with FIG. 9, the obtaining module and the processing module in the content display device implement the same functions as the processor in FIG. 10, and the storage module in the content display device implement the same functions as the memory in FIG. 10.

For explanation of relevant content in this embodiment, reference may be made to the above method embodiments, and details will not be repeated here.

Through the description of the above embodiments, those skilled in the art may clearly understand that, for the convenience and brevity of description, only a situation where the functional modules are divided in the above manner is described as an example for illustration. In practical applications, the above functions may be allocated to and completed by different functional modules according to needs. That is, internal structures of the device may be divided into different functional modules to complete all or part of the functions described above. As for specific working processes of the above-mentioned systems, devices, and units, reference may be made to corresponding processes in the foregoing method embodiments, and details will not be repeated here.

Some embodiments of the present disclosure further provide a non-transitory computer-readable storage medium. The non-transitory computer-readable storage medium has stored thereon instructions that, when executed by a computer, cause the computer to perform the content display method provided by the above embodiments.

The non-transitory computer-readable storage medium may be, but is not limited to, for example, an electrical, magnetic, optical, electromagnetic, infrared, or semiconductor system, apparatus, or device, or a combination of any of the above. More specific examples (non-exhaustive list) of the computer-readable storage medium include: electrical connections with one or more wires, portable computer disks, hard disks, RAM, ROM, erasable programmable read-only memory (EPROM), registers, hard disks, optical fibers, CD-ROM, optical storage devices, magnetic storage devices, or any suitable combination of the above, or any other forms of computer-readable storage media known in the art. An exemplary storage medium is coupled to the processor, so that the processor can read information from the storage medium, and write information into the storage medium. Of course, the storage medium may also be an integral part of the processor. The processor and the storage medium may be located in an application specific integrated circuit (ASIC). In the embodiments of the present disclosure, the computer-readable storage medium may be any tangible medium that contains or stores a program, and the program may be used by or in combination with an instruction execution system, apparatus, or device.

The foregoing descriptions are merely specific implementation manners of the present disclosure, but the protection scope of the present disclosure is not limited thereto. Any changes or replacements within the technical scope disclosed by the present disclosure shall be included in the protection scope of the present disclosure. Therefore, the protection scope of the present disclosure shall be subject to the protection scope of the claims.

What is claimed is:

1. A content display device, comprising:
a processor configured to:
obtain target information, the target information including vehicle state information at a current moment and first information, the first information being used to characterize a facial expression of a driver in a vehicle at the current moment, and the vehicle state information including vehicle speed, vehicle position, and driving time;
determine a target tag according to a first database at the current moment and the target information, the first database including a plurality of pieces of historical information corresponding to the driver in a historical period, each piece of historical information including vehicle state information at a first moment, a facial expression of the driver at the first moment, and a first tag, the first moment falling within the historical period, and the first tag being a tag determined according to the vehicle state information at the first moment and the facial expression of the driver at the first moment; and
obtain top M pieces of content in the target tag and display the content on a display screen, M being a positive integer.

2. The content display device according to claim 1, wherein the processor is configured to:
receive a face image of the driver at the current moment; and
determine the first information by using a preset image processing algorithm to process the face image.

3. The content display device according to claim 2, wherein the processor is further configured to:
determine the first database corresponding to the driver according to the face image.

4. The content display device according to claim 1, wherein the processor is further configured to:
determine first historical information according to a similarity between the target information and each piece of historical information, the first historical information being historical information, among the plurality of pieces of historical information, a similarity between which and the target information satisfies a preset condition; and
determine the target tag according to the first historical information.

5. The content display device according to claim 4, wherein the plurality of pieces of historical information are represented by an N-dimensional space model, each dimension representing an attribute, the attributes including facial expression of the driver, vehicle speed, vehicle position, and driving time, N being a positive integer greater than 3; and the processor is configured to:
determine N-tuple of first coordinates and a plurality of N-tuples of second coordinates, the N-tuple of first coordinates being coordinates of the target information in the N-dimensional space model, and the plurality of N-tuples of second coordinates being coordinates of the historical information in the N-dimensional space model;
calculate a spatial distance between the N-tuple of first coordinates and each N-tuple of second coordinates, the spatial distance being used to characterize the similarity between the target information and the historical information; and
determine the first historical information according to a plurality of spatial distances.

6. The content display device according to claim 1, wherein the processor is further configured to:
store the target information and the target tag in the first database.

7. A content display method, comprising:
obtaining target information, the target information including vehicle state information at a current moment and first information, the first information being used to characterize a facial expression of a driver in a vehicle at the current moment, and the vehicle state information including vehicle speed, vehicle position, and driving time;
determining a target tag according to a first database at the current moment and the target information, the first database including a plurality of pieces of historical information corresponding to the driver in a historical period, each piece of historical information including vehicle state information at a first moment, a facial expression of the driver at the first moment, and a first tag, the first moment falling within the historical period, and the first tag being a tag determined according to the vehicle state information at the first moment and the facial expression of the driver at the first moment; and
obtaining top M pieces of content in the target tag and displaying the content, M being a positive integer.

8. The content display method according to claim 7, wherein obtaining the target information includes:
receiving a face image of the driver at the current moment; and
determining the first information by using a preset image processing algorithm to process the face image.

9. The content display method according to claim 8, wherein before determining the target tag according to the first database at the current moment and the target information, the method further comprises:
determining the first database corresponding to the driver according to the face image.

10. The content display method according to claim 7, wherein determining the target tag according to the first database at the current moment and the target information includes:
determining first historical information according to a similarity between the target information and each piece of historical information, the first historical information being historical information, among the plurality of pieces of historical information, a similarity between which and the target information satisfies a preset condition; and
determining the target tag according to the first historical information.

11. The content display method according to claim 10, wherein the plurality of pieces of historical information are represented by an N-dimensional space model, each dimension representing an attribute, the attributes including facial expression of the driver, vehicle speed, vehicle position, and driving time, N being a positive integer greater than 3; and determining first historical information according to the similarity between the target information and each piece of historical information includes:
determining N-tuple of first coordinates and a plurality of N-tuples of second coordinates, the N-tuple of first coordinates being coordinates of the target information in the N-dimensional space model, and the plurality of N-tuples of second coordinates being coordinates of the historical information in the N-dimensional space model;
calculating a spatial distance between the N-tuple of first coordinates and each N-tuple of second coordinates, the spatial distance being used to characterize the similarity between the target information and the historical information; and
determining the first historical information according to a plurality of spatial distances.

12. The content display method according to claim 7, further comprising:
storing the target information and the target tag in the first database.

13. A non-transitory computer-readable storage medium having stored thereon instructions that, when executed by a computer, cause the computer to perform the content display method according to claim 7.

14. A computer program product comprising computer instructions, carried on a non-transitory computer-readable storage medium, that, when executed on a computer, causes the computer to perform the content display method according to claim 7.

15. A content display system comprising a central processing unit (CPU), the CPU being configured to perform the content display method according to claim 7.
